(19) United States
(12) Patent Application Publication
(10) Pub. No.: US 2025/0005791 A1
(43) Pub. Date: Jan. 2, 2025

(54) APPARATUS LOCALISATION

(71) Applicant: Oxford University Innovation Limited, Oxford (GB)

(72) Inventors: Sundara Tejaswi DIGUMARTI, Oxford (GB); Maurice FALLON, Oxford (GB); Lintong ZHANG, Oxford (GB)

(21) Appl. No.: 18/617,722

(22) Filed: Mar. 27, 2024

(30) Foreign Application Priority Data
Jun. 28, 2023 (GB) 2309783.5

(51) Int. Cl. G06T 7/73; G01S 17/89; G06T 7/11; G06V 20/70

(52) U.S. Cl. CPC G06T 7/74; G01S 17/89; G06T 7/11; G06V 20/70; G06T 2207/10028; G06T 2207/20084

(57) ABSTRACT

Examples disclosed herein provide computer-implemented methods and apparatus of localisation of an imaging apparatus in an environment. The method comprises: receiving a point cloud map indicative of the environment, the point cloud map captured by the imaging apparatus located at a position within the environment; segmenting the point cloud map into a plurality of object segments each comprising an object feature; assigning a unique descriptor to each of the object features; matching at least one of the object features to a corresponding feature in an existing map of the environment using the unique descriptor; and localising the position of the imaging apparatus in the environment based on the at least one matched object feature.

### CROSS-REFERENCE TO RELATED APPLICATION

This application claims the benefit of and priority to GB 2309783.5, filed Jun. 28, 2023, which is entirely incorporated herein by reference.

### TECHNICAL FIELD

The present disclosure relates to apparatus localisation, and, in particular, localisation of an imaging apparatus in an environment. Examples relate to an apparatus, computer-implemented methods, and machine-readable media having program code stored thereon configured to perform localisation of an imaging apparatus in an environment.

### BACKGROUND

Examples disclosed here set out apparatuses and methods of localising an apparatus in an environment. Localisation is a fundamental capability needed for mobile robots to navigate their environment and make decisions. There have been many studies on vision, light detecting and ranging technology (lidar), and radio detecting and ranging (radar)-based localisation. Many popular localisation methods using visual and lidar sensors have been proposed. Among visual-based approaches, visual teach-and-repeat is a popular method, where a robot first constructs a visual prior map and then localises on its repeat phase. Compared to image-based camera solutions, modern 3D lidar sensors are view-invariant, robust to lighting changes, and can operate when the path travelled is offset from the original path. Given that lidar is a precise and long-range sensor, lidar localisation has been heavily researched in outdoor environments, especially in the context of autonomous driving.

However, there are fewer approaches for indoor environments because these environments contain more complex structures and clutter, hence fewer clear separations between objects in lidar scans. Methods designed primarily for outdoor scenarios are inadequate for an indoor setting. There is therefore a need in the art to improve localisation technologies, particularly in indoor environments.

### SUMMARY

According to an aspect, there is provided a computer-implemented method of localisation of an imaging apparatus in an environment, the method comprising: receiving a point cloud map indicative of the environment, the point cloud map captured by the imaging apparatus located at a position within the environment; segmenting the point cloud map into a plurality of object segments each comprising an object feature; assigning a unique descriptor to each of the object features; matching at least one of the object features to a corresponding feature in an existing map of the environment using the unique descriptor; and localising the position of the imaging apparatus in the environment based on the at least one matched object feature.

The method may comprise matching a plurality of the object features to respective corresponding features in the existing map of the environment using the unique descriptors of the plurality of the object features; and localising the position of the imaging apparatus in the environment based on the plurality of matched object features. Each object feature may belong to an object category indicating the type of object, and at least two of the plurality of the object features belong to different object categories.

The point cloud map may represent an image of the environment captured by the imaging apparatus in a single position and a single orientation within the environment.

Segmenting the point cloud map may comprise representing the point cloud map using sparse tensors. Segmenting the point cloud map may comprise, for each point in the point cloud map: predicting a semantic label indicating an object class of the object feature comprising the point; and predicting an instance label indicating a unique instance of the object feature comprising the point. Segmenting the point cloud map may comprise grouping a plurality of points in the point cloud map, the plurality of points associated with an object feature.

The point cloud map may be obtained using depth imaging or depth scanning. Grouping the plurality of points is performed using an adaptive radius threshold proportionate to a vertical distance between two depth imaging or depth scanning beams used to capture the point cloud map.

Assigning the unique descriptor comprises: for each of the object features, each of the object features comprising a plurality of points of the point cloud map; using a network comprising a series of convolutional layers to generate a plurality of point descriptors each corresponding to a particular point in the plurality of points of the object feature; and pooling the plurality of point descriptors to generate the unique descriptor of the object feature. Assigning the unique descriptor may be performed using a neural network.

Matching at least one of the object features to a corresponding feature in an existing map of the environment using the unique descriptor may comprise: matching one or more object features in the point cloud map to a corresponding feature in the existing map; and identifying a closest match to the corresponding feature from the one or more matched object features using a correspondence grouping method.

The plurality of object segments may comprise a first object feature in a first object segment and a second object feature in a second object segment. The first object feature may comprise a different number of points of the point cloud map than the second object feature.

The environment may be an indoor environment. The imaging apparatus may be a lidar and the point cloud map captured by the imaging apparatus may be a lidar map.

Localising the position of the imaging apparatus may comprise identifying the spatial position and directional orientation of the imaging apparatus.

According to another aspect, there is provided an apparatus configured to localise an imaging apparatus in an environment, the apparatus comprising: an input module configured to receive a point cloud map indicative of an environment, the point cloud map captured by the imaging apparatus located at a position within the environment; a segmentation module configured to segment the point cloud map into a plurality of object segments each comprising an object feature; a descriptor module configured to assign a unique descriptor to each of the object features in the point cloud map; a matching module configured to match at least one of the object features to a corresponding feature in an existing map of the environment using the unique descriptor; and a localisation module configured to localise the position of the imaging apparatus in the environment based on the at least one matched object feature.

The segmentation module may comprise a neural network configured to segment the point cloud map into the plurality of object segments. The descriptor module may comprise a neural network configured to assign the unique descriptor to each of the object features.

The apparatus may comprise the imaging apparatus located with the apparatus. The imaging apparatus may be configured to capture the point cloud map and provide the point cloud map to the input module. The localisation module may be configured to localise the position of the apparatus.

According to another aspect, there is provided a machine-readable medium having program code stored thereon which, when executed by a computer or any apparatus disclosed herein, causes the machine to perform any method or operation disclosed herein.

### BRIEF DESCRIPTION OF THE DRAWINGS

Examples are further described hereinafter with reference to the accompanying drawings, in which:

FIG. 1 illustrates a method of localisation of an imaging apparatus in an environment according to examples disclosed herein;

FIG. 2 shows an apparatus capable of localisation of an imaging apparatus in an environment according to examples disclosed herein;

FIG. 3 shows a process of localisation of an imaging apparatus in an environment according to examples disclosed herein;

FIG. 4a shows a process of matching object features via descriptor and geometric matching, and FIG. 4b shows an example result of matching object features in a captured image to corresponding objects in an existing map according to examples disclosed herein;

FIG. 5 shows an segmentation architecture for segmenting a point cloud map according to examples disclosed herein;

FIG. 6 shows an instance descriptor network architecture for assigning unique descriptors to object features according to examples disclosed herein;

FIG. 7 shows example datasets representing existing maps;

FIG. 8 shows an example result of point cloud map segmentation according to examples disclosed herein; and

FIG. 9 shows an example result of a precision/recall curve for test data in a descriptor network, and a subset of the test data, according to examples disclosed herein.

Throughout the description and the drawings, like reference numerals refer to like parts.

### DETAILED DESCRIPTION

Localisation is a fundamental capability needed for mobile robots to navigate their environment and make decisions. There have been many studies on vision, lidar, and radar-based localisation. The parent problem of Simultaneous Localisation and Mapping (SLAM) concerns a robot determining its pose while building a map of its environment concurrently. Localisation, or place recognition, can contribute to SLAM by helping to close loops (that is, to determine if a robot or sensing system has returned to a previously visited location), or to determine the robot's position in a fixed prior map. Many popular localisation methods using visual and lidar sensors have been proposed. Among visual-based approaches, visual teach-and-repeat is a popular methods, where a robot first constructs a visual prior map and is then localised within it on its repeat phase.

Compared to image-based camera solutions, modern 3D lidar sensors are view-invariant, robust to lighting changes, and can operate when the path travelled is offset from the original path. Given that lidar is a precise and long-range sensor, lidar localisation has been heavily researched in outdoor environments, especially in the context of autonomous driving. However, there are fewer approaches for indoor environments because these environments contain more complex structures and clutter, hence fewer clear separations between objects in lidar scans. In an indoor environment, there are many different classes of objects. Indoor scenes can vary greatly: from bare box-shaped rooms with four walls to narrow corridors with two long walls. Room surfaces may often be covered with objects such as electronics, hanging art, ceiling lights, bookcases, and various decorative objects. Localisation algorithms cannot rely on flat ground assumptions as there is often an incomplete view of the floor. In addition, there may be changes in levels, with steps and staircases. Nevertheless, it is important to localise in these indoor scenarios to enable robots to operate robustly in complex office buildings, construction sites, warehouses, other commercial environments and other indoor locations.

Examples disclosed herein aim to solve problems with localisation, in part inspired by how humans perceive the world and reach the “I know where I am” moment. By memorizing and recognizing the distinctive structures and unique objects inside a space, humans can spatially locate themselves in the environment. Based on the same principle, examples disclosed herein can make use of individual object instances to localise. Different from existing approaches that rely on primitive shapes or other handcrafted features, examples disclosed herein can learn to segment and match individual objects to the prior scene. These scenes may include both fixed objects (e.g. walls, ceilings, beams) and movable objects (e.g. chairs, desks), in order to tolerate active dynamics and longer term scene changes.

In some examples, a segmentation network is used and trained with accurate class labels, by using a simulator to synthesize and automatically annotate every point in the obtained captured point cloud map of the environment. This advantageously allows onerous point cloud labelling to be avoided. To overcome the challenge of imperfect instance segmentation, examples disclosed herein may use a sparse convolutional descriptor network that is configured to infer many instances simultaneously and can tolerate mild changes in the instance point cloud.

Examples disclosed herein provide a novel learning-based lidar localisation approach for environments including indoor environments, which can process point cloud data such as dense lidar scans. Examples disclosed herein may advantageously be able to run on a mobile GPU in real time. Examples disclosed herein can provide an improved panoptic segmentation network that works with single point cloud map captures, such as a single lidar scan. Examples disclosed herein utilise a fast and efficient descriptor network configured to learn object instances, even with a variable number of input points. Examples disclosed herein provide excellent performance on indoor localisation compared to other known segment-based methods, in some cases achieving two to four times more detection. By predicting both the semantic mask and instance label of each point in a point cloud map, examples disclosed herein provide an improved panoptic segmentation method to allow for localisation even in challenging environments such as indoor environments.

Specifically focusing on indoor localisation, known methods often focus on planar floors or geometric features which describe corners and intersections as landmarks for localisation. In comparison to these approaches, examples disclosed herein need not rely on planes or any other explicit structure to constrain localisation performance. Instead, examples disclosed herein are capable of segmenting a captured image of an environment into segments including semantically meaningful objects, and matching them between different observations of the scene, to perform localisation. Additional aspects of the present disclosure can be found in the paper appended hereto as Addendum A which forms part of the present disclosure and which is incorporated as if fully set forth herein.

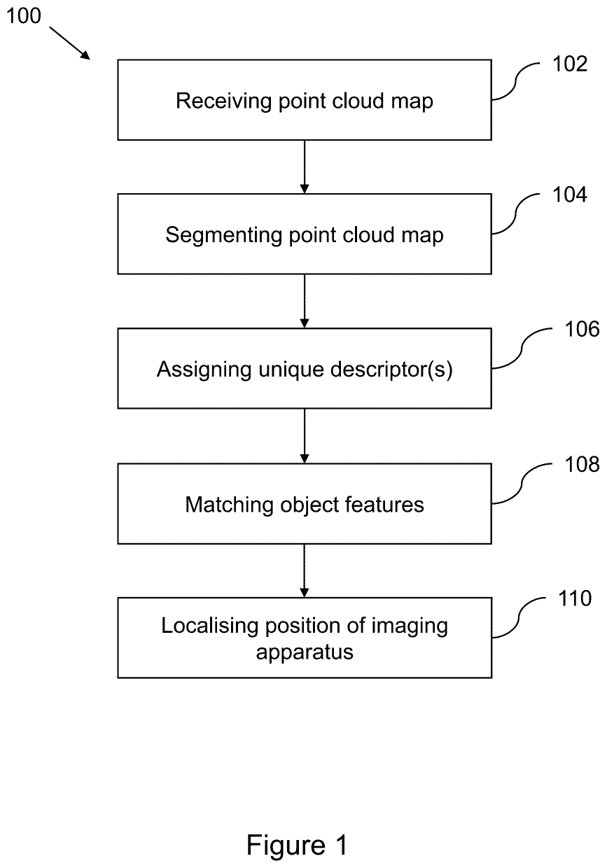

FIG. 1 illustrates a method 100 of localisation of an imaging apparatus in an environment. Where the term “imaging apparatus” is used, the term “scanning apparatus” may equally well be used (for example, a lidar imager may commonly be called a lidar scanner). The method is a computer-implemented method of localisation of an imaging apparatus in an environment. The environment may be an indoor environment (e.g. inside a room, corridor or underground car park) but the method may also be used in other environments such as outdoor environments (e.g. an outdoor car park, street or park), or covered outdoor environments (e.g. under a shelter with a view of the outdoors, such as a barn in a farmyard or covered marketplace with open walls). The imaging apparatus may be a lidar. The point cloud map captured by the imaging apparatus may in such examples be a lidar map. In other examples, the imaging apparatus may be any other imaging device or camera which can capture depth or map in three dimensions such as an optical or IR camera.

The method 100 comprises receiving a point cloud map indicative of the environment 102. The point cloud map has been captured by the imaging apparatus located at a position within the environment. The point cloud map is a plurality of points distributed in 3D space and is representative of the imaged environment. For example, the point cloud map may be a series of points obtained in a lidar scan. In some examples, the point cloud map represents an image of the environment captured by the imaging apparatus in a single position and a single orientation within the environment, so the point cloud map data is obtained in a single lidar scan of the environment.

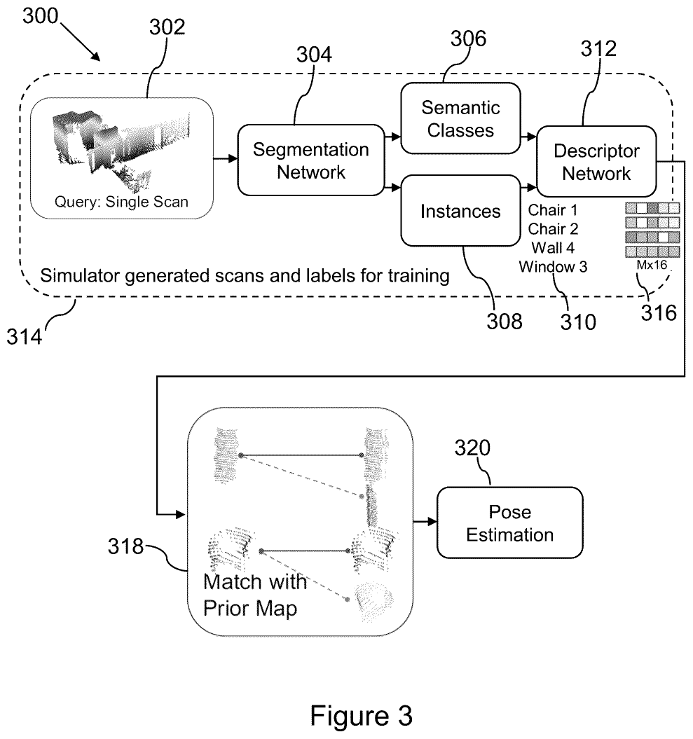

The method 100 comprises segmenting the point cloud map into a plurality of object segments each comprising an object feature 104. This segmentation is discussed in more detail with reference to FIGS. 3 to 5.

The method 100 comprises assigning a unique descriptor to each of the object features 106. This assignment of descriptors is discussed in more detail with reference to FIGS. 3 and 6.

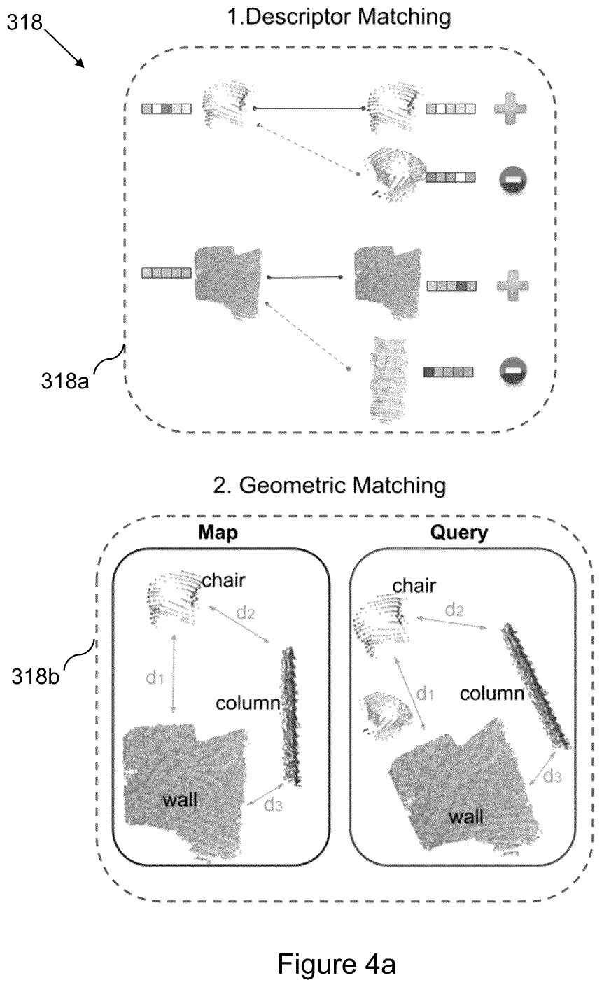

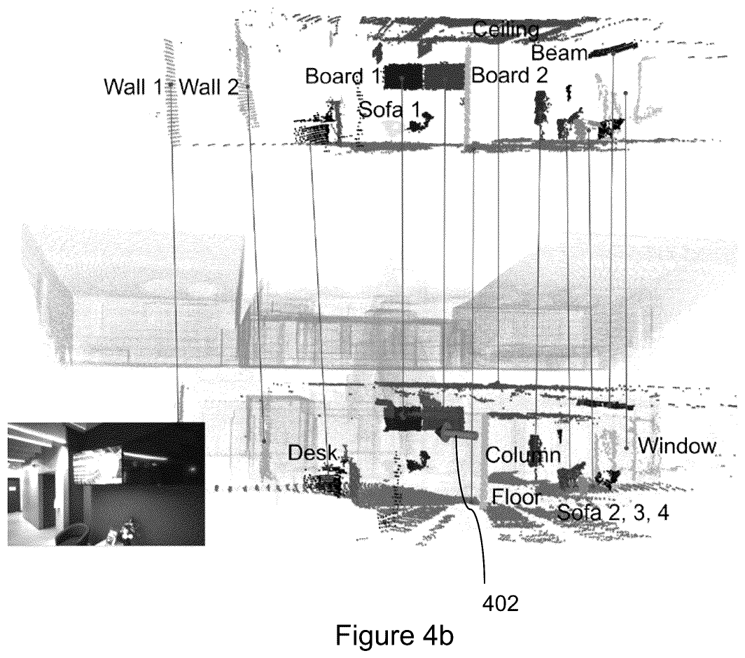

The method 100 comprises matching at least one of the object features to a corresponding feature in an existing map of the environment using the unique descriptor 108. This assignment of descriptors is discussed in more detail with reference to FIGS. 3, 4a and 4b.

The matching may be between more than one object feature in the point cloud map and a respective corresponding feature in the existing map. That is, the method may comprise matching a plurality of the object features to respective corresponding features in the existing map of the environment using the unique descriptors of the plurality of the object features. Each object feature may belong to an object category indicating the type of object. In examples in which a plurality of object features are matches to objects in the existing map, at least two of the plurality of the object features may belong to different object categories.

The method 100 comprises localising the position of the imaging apparatus in the environment based on the at least one matched object feature 110. In examples where more than one object instance is matches to an object in the existing map, localising the position of the imaging apparatus in the environment may be based on the plurality of matched object features. This is illustrated in FIGS. 4a and 4b discussed below.

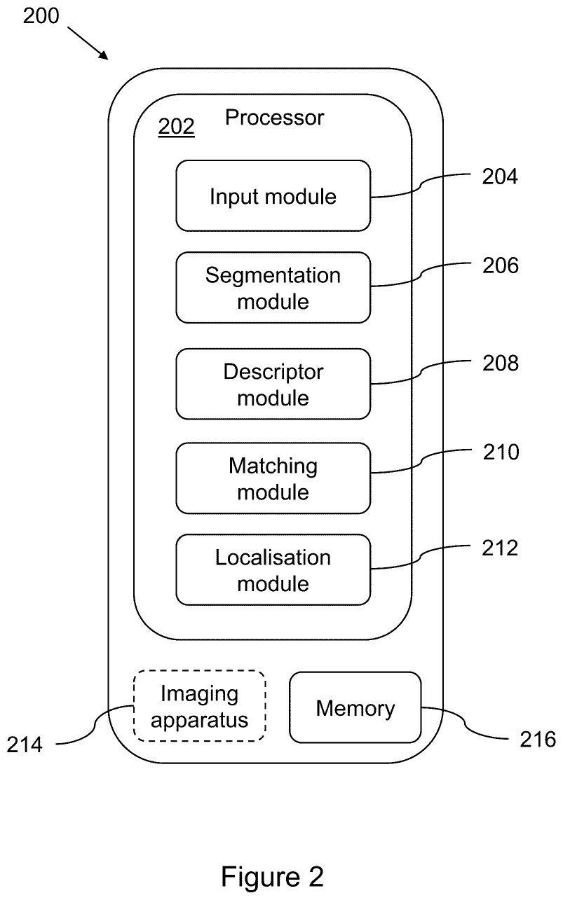

FIG. 2 shows an apparatus 200 capable of localisation of an imaging apparatus 214 in an environment. The apparatus 200 comprises a processor 200 and a memory 216. The apparatus 200 in this example comprises at least one processor 202 and a memory 216 connected to the at least one processor 202. The memory 216 may be considered an example of a machine-readable medium having program code stored thereon. The program code (software) may, when executed by the processor 202 in communication with elements of any apparatus 200 disclosed herein, cause the processor 202 to perform any operation or operations disclosed herein. Such program code may be stored in the form of volatile or non-volatile storage 216 such as on a storage device. Such a storage device may be a ROM, RAM, chip memory, a memory device, integrated circuit memory, or an optically or magnetically readable medium such as CD, DVD, or magnetic disk or tape. Computer program code as disclosed herein may be conveyed electronically via any medium such as a communication signal carried over a wired or wireless connection and examples suitably encompass the same.

The imaging apparatus 214 in some examples may be a part of the apparatus 200, for example a lidar, depth scanning, or depth imaging camera (as an imaging apparatus 214) may be part of a portable electronic device (as an apparatus 200) such as a smartphone. In other examples, the imaging apparatus 214 may be separate from and in electronic (wired or wireless) communication with the apparatus 200. For example, a stand-alone lidar or depth imaging camera (as an imaging apparatus 214) may be present in the environment and in electronic communication with a separate apparatus 200 (which may also be in the same environment to be imaged or may be remote from the imaging apparatus in a different environment which is not imaged). In other words, the apparatus 200 may comprise the imaging apparatus 214 located with the apparatus 200; the imaging apparatus 214 may be configured to capture the point cloud map and provide the point cloud map to the input module 204; and the localisation module 212 may be configured to localise the position of the apparatus 200 in the environment.

The separate apparatus 200 may be a server or computer, for example. Advantageously, the apparatus 200 may comprise the imaging apparatus 214 as illustrated in FIG. 2 in a single portable device, and the methods disclosed herein may be performed by the processing power available in a portable device such as a typical smartphone, without necessarily requiring higher processor such as that typically found in a server. The use of sparse tensors supports the overall method to be able to run on a portable device processor, for example.

The apparatus 200 is configured to localise an imaging apparatus 214 in an environment. The apparatus 200 comprises an input module 204 configured to receive a point cloud map indicative of an environment, wherein the point cloud map is captured by the imaging apparatus 214 located at a position within the environment. The apparatus 200 comprises a segmentation module 206 configured to segment the point cloud map into a plurality of object segments each comprising an object feature. The segmentation module may comprise a neural network configured to segment the point cloud map into the plurality of object segments The apparatus 200 comprises a descriptor module 208 configured to assign a unique descriptor to each of the object features in the point cloud map. The descriptor module may comprise a neural network configured to assign the unique descriptor to each of the object features. The apparatus 200 comprises a matching module 210 configured to match at least one of the object features to a corresponding feature in an existing map of the environment using the unique descriptor. The apparatus 200 comprises a localisation module 212 configured to localise the position of the imaging apparatus 214 in the environment based on the at least one matched object feature.

Examples disclosed herein include a machine-readable medium (which may be a non-transient machine-readable medium) having program code stored thereon which, when executed by a computer, causes the computer to perform any of methods disclosed herein. The medium may be the memory 216 of the apparatus 200 in some examples

The following discussion sets out the problem of localisation and examples of how the methods and apparatus disclosed herein can address the problem, in detail, with reference to FIGS. 3 to 9.

The problem may be defined as localizing a single query lidar scan Q={qᵢ∈ [symbol] ³} within a prior map [symbol] ={P₁, P₂, . . . Pₜ_{_{i−1}}}. The query scan Q is the captured point cloud map obtained by the imaging apparatus (e.g. a lidar sensor) at a position in the environment. The pose of the lidar is determined at time tᵢ as follows,

$${x}_{i} {=}^{Δ} [ {t}_{i} , {R}_{i} ] ∈ SO ( 3 ) \times {ℝ}^{3} \qquad ( 1 )$$

where tᵢ∈ [symbol] ³ is the translation, Rᵢ∈SO(3) is the orientation of Q in [symbol] .

The map [symbol] is a collection of registered lidar scans, Pₜ={m_{i,t}∈ [symbol] ³}, accumulated over time (i.e. the map [symbol] is the existing map).

Approaching the problem at the level of objects, the pose xᵢ may be computed by matching object instances identified in the query scan Q with those previously identified in the map [symbol] .

A first step is to partition the prior map scans (i.e. existing map) into meaningful object instances. Prior approaches have used planes or region growing methods to segment objects with a scan which can work in outdoor environments because sizes of outdoor objects and the separation between them is many times greater than the average inter-point distance in a lidar scan. However, in indoor environments, due to the close proximity of objects with each other, space partitioning and region growing approaches perform poorly. In the approach disclosed here, semantic object segmentation is used to partition the environment into object segments (there will be at least one object present and captured in the point cloud map image). The object may be a distinguishable objects such as furniture, doors and windows.

Objects observed in a query scan may appear quite differently from those in the prior map. This could be due to observing the object from a different viewpoint in the query scan than from which it was observed in the prior map. Partial observations from different viewpoints, occlusions by other objects, or different point sampling densities (if the query and map scans were taken from different ranges) all contribute to variation in the reconstruction of an object instance. Due to this variation in the observations, finding matches by aligning a 3D point cloud of the objects between the query and the map as in typical known methods can result in poor pose estimation.

To help overcome this issue, examples disclosed herein use object level descriptors that capture the distinguishing features of each object. Estimating pose by matching these descriptions provides some robustness against the variations which occur due to differing viewpoints and partial observations. Descriptor matching also requires lower computational and memory resources as the dimensions of the descriptor are typically smaller than the number of points in each object.

After this step, descriptors of the objects segmented from the query scan are matched against a database of objects with descriptors in the map to determine correspondences between the query scan and the map. Descriptors may be grouped based on their similarity and to find correspondences. Finally, in some examples, RANSAC (random sample consensus) may be used on a subset of correspondences to estimate the six degrees of freedom (6-DOF, e.g. x, y, z, roll, pitch, yaw) pose of the lidar sensor by aligning the matched objects between the two scans. In examples disclosed herein, both the instance segmentation module and the instance description module may be modelled using deep neural networks which work directly on 3D point cloud data. Typical lidar scans are point clouds with large amounts of spatially sparse data. Sparse tensors may be used to represent this data. That is, in methods disclosed herein, segmenting the point cloud map may comprise representing the point cloud map using sparse tensors, e.g. by converting the point cloud map into one or more sparse tensor representations.

Both networks used to model the instance segmentation module and the instance description module may use the Spatially Sparse Convolution Library (SpConv) which uses sub-manifold sparse convolutions in its neural network implementation. Sub-manifold convolutions have an advantage that they maintain a greater degree of sparsity than other sparse convolutions by overcoming the issue of submanifold dilation. As a result, deeper networks with lower memory and computational requirements, and practical real-time capabilities can be constructed to work with large amounts of sparse data. Furthermore, sub-manifold sparse convolutions may be more efficient than alternate approaches that use spatial partitioning schemes.

FIG. 3 shows a process 300 of localisation of an imaging apparatus in an environment which corresponds to the method of FIG. 1, and which may be performed by the apparatus of FIG. 2. The process 300 comprises receiving a single scan query map 302, which can be considered to be a point cloud map indicative of the environment. The point cloud map is captured by the imaging apparatus located at a position within the environment. The point cloud map is segmented by a segmentation network 304 into a plurality of object segments each comprising an object feature. In some examples, segmenting the point cloud map is performed using a neural network. Thus the segmentation network may be a neural network such as a deep neural network.

In relation to instance segmentation, the instance segmentation module 304 may be a point-wise panoptic segmentation network. Given a lidar scan, i.e. a set of N 3D points, P={p₁, p₂, . . . P_{N}|Pₖ∈ [symbol] ³ as input, the network 304 predicts for each point pₖ a semantic label sₖ corresponding to the object class that the point belongs to (e.g. chair, table, wall, ceiling) and an instance label iₖ representing the unique object that the point corresponds to (e.g. chair1, chair14 or chair42). Thus, in some examples, segmenting the point cloud map 304 may comprise grouping a plurality of points in the point cloud map, the plurality of points associated with an object feature.

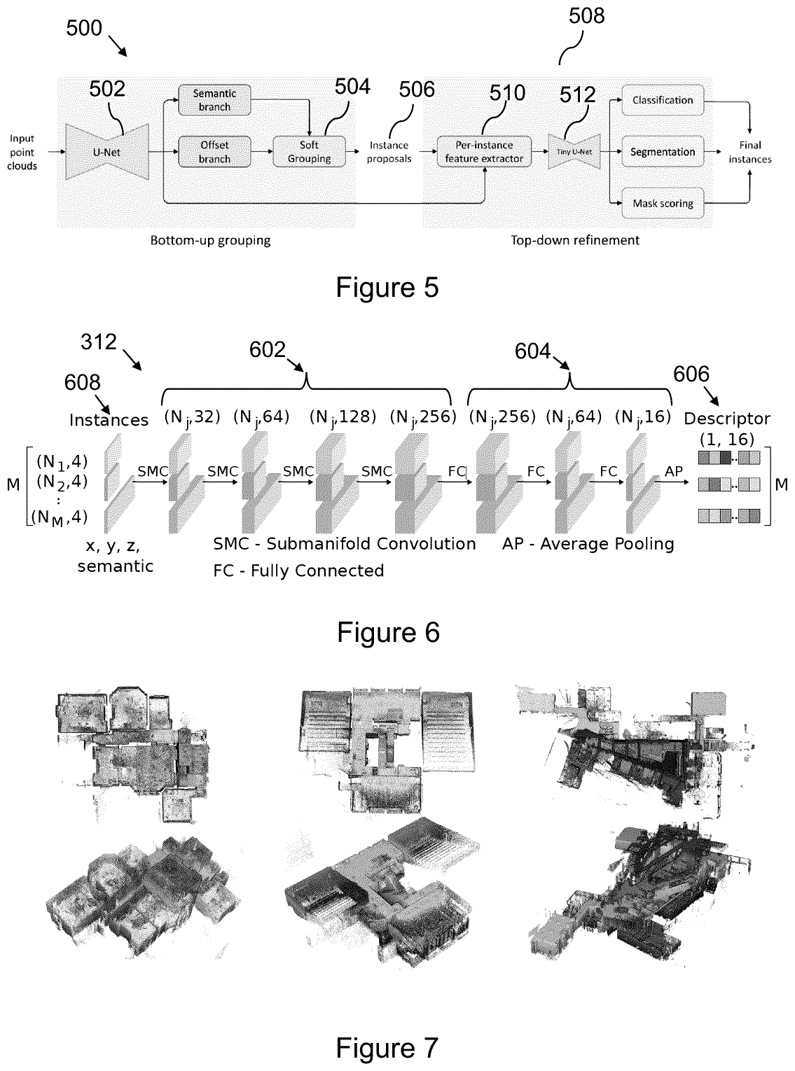

In an example, the SoftGroup network architecture (a 3D instance segmentation method which uses bottom-up soft grouping and top-down refinement) may be used to construct this module as shown in FIG. 5. FIG. 5 shows an example of a segmentation architecture for segmenting a point cloud map. This architecture 500 may consist of three stages: a U-Net based point-wise prediction network 502 that takes the input point clouds as input and generates semantic scores and an offset vector representing the distance from the point to the instance it belongs to; a SoftGrouping step 504 where points are grouped by similarity of their semantic scores and their spatial distance to generate instance proposals 506 and a refinement network 508 that extracts features 510 for every instance proposal and then uses a tiny U-Net based network 512 to refine the proposals and provide final instances as output. A fixed distance threshold may be used to group the points in the SoftGrouping step 504 of the SoftGroup architecture and works well for point clouds with uniform sampling density.

In lidar scans, the sampling density may be much lower along the vertical axis as compared to the density in the horizontal axis and points become further separated as the sensing range increases. If a fixed distance threshold is used for grouping, then the number of instance proposals may be overestimated in regions further away from the sensor; this can lead to incorrect object segmentation. This potential issue is addressed in some examples by using an adaptive radius threshold proportionate to the vertical distance between two beams. That is, in some examples, the point cloud map may be obtained using depth imaging or depth scanning, and grouping the plurality of points is performed using an adaptive radius threshold proportionate to a vertical distance between two depth imaging or depth scanning beams used to capture the point cloud map.

Typically, 3D lidars rotate 360° horizontally and have a vertical field of view of θ radians. For a point pᵢ(xᵢ, yᵢ, zᵢ) resulting from a lidar beam in a point cloud, with the sensor origin O, its radius threshold pᵢ is:

$$\begin{matrix}{ρ}_{i} = α \cdot d ( {p}_{i} , O ) \cdot tan ( \frac{θ}{{N}_{beam}} ) = α \cdot d ( {p}_{i} , O ) \cdot \frac{θ}{{N}_{beam}} & ( 2 ) \\ where d ( {p}_{i} , O ) = \sqrt{{x}_{i}^{2} + {y}_{i}^{2} + {z}_{i}^{2}} & ( 3 )\end{matrix}$$

and N_{beam} is the number of lidar beams and a is a constant scale factor.

The output of panoptic segmentation network is a set of [symbol] object instances [symbol] ={I₁, I₂, . . . , I_{M}} where each object instance is a set of Nⱼ points representing the 3D coordinates of the point and the semantic label sⱼ of the object, i.e. Iⱼ={h_{k,j}|k={1, 2 . . . N}, h_{k,j}=(p_{k,j},sⱼ)}.

Returning to FIG. 3, the process 300 in this example comprises a step of assigning semantic classes 306 to the object segments, and assigning instances of the object segments 308, such as “chair 1, chair 2, wall 4, window 3” 310. The process 300 comprises assigning a unique descriptor to each of the object features by a descriptor network 312. That is, in methods disclosed herein, segmenting the point cloud map may comprise, for each point in the point cloud map 302: predicting a semantic label (for example by the semantic classes module 306) indicating an object class of the object feature comprising the point; and predicting an instance label (for example, by the instances module 308) indicating a unique instance of the object feature comprising the point.

In relation to instance description, after the object instances are segmented by the segmentation network 304 and a semantic class and instance of each object feature instance is predicted 310, the next step is to generate descriptors 316 for each of the instances. An overview of an example network 600 is shown in FIG. 6. FIG. 6 shows an example instance descriptor network architecture 600 for assigning unique descriptors to object features. The input 608 is a set of object instances with a variable number of points per instance, with each point representing the 3D coordinates of the point and the semantic label of the object.

The network 312 is designed to be small and fast: it can take all instances in one batch with varying number of points as input. In this example, this is done using the instance descriptor network 312, which comprises, in this example, four submanifold sparse convolutional layers 602 of increasing feature size followed by three fully connected layers 604, with a dropout layer before the final fully connected layer 606. The input 608 to the network 312 is a set of object instances 608, [symbol] ={I₁, I₂, . . . , I_{M}}, the output 608 of the instance segmentation network 304, with each instance Iⱼ containing Nⱼ points (with Nⱼ varying for at least one object compared with the other object(s); and in some examples, varying for each object). The descriptor network output for each object instance Iⱼ is an Nⱼ×D tensor where every row is a descriptor of length D for one point in the object instance. Thus in some examples, the plurality of object segments may comprise a first object feature in a first object segment and a second object feature in a second object segment, wherein the first object feature comprises a different number of points of the point cloud map than the second object feature.

Finally, in the example of FIG. 6, an average pooling layer computes the average of the Nⱼ descriptors to create a single descriptor of length D for each object instance. This results in an output vector of dimensions [symbol] ×D, where [symbol] is the number of object instances. The network in this example is trained using triplet loss. If α, p, n∈ [symbol] ^{D} are the descriptors for an anchor, the corresponding positive element and a negative element respectively, then the triplet loss [symbol] ₜᵣᵢₚₗₑₜ can be calculated as:

$${ℒ}_{triplet} ( a , p , n ) = max \{ d ( a , p ) - d ( a , n ) + m , 0 \} \qquad ( 4 )$$

where d(x,y)=∥x−y∥₂ is the pairwise distance between the descriptors; and the margin 77% is set to 1. The average loss over all the samples in a mini-batch is considered as the loss during training.

That is, assigning the unique descriptor may comprise for each of the object features, each of the object features comprising a plurality of points of the point cloud map: using a network 312 comprising a series of convolutional layers to generate a plurality of point descriptors each corresponding to a particular point in the plurality of points of the object feature; and pooling the plurality of point descriptors to generate the unique descriptor 316, 606 of the object feature. Assigning the unique descriptor may be performing using a neural network.

The steps of receiving input data 302, segmentation 304, classification 306, 308 and descriptor assignment 312 of an obtained scan have also been performed using existing (prior) map data of the environment, as indicated by the dotted boundary 314 labelled as “simulator generated scans and labels for training”. In this way there is a known body of data to compare the captured point cloud data to.

After the descriptor or descriptors 316 are identified, for example by a 1×16 vector (a plural number of M descriptors may be indicated by a “M×16” matrix as illustrated), the descriptors are matched to object instances in the prior map 318. That is, the process 300 comprises matching 318 at least one of the object features to a corresponding feature in an existing map of the environment using the unique descriptor. In an example, for each instance in the query scan 302, its N closest descriptors are obtained from a database of instances of the prior map. This generates a list of instance-to-instance correspondences. A correspondence grouping method may then be used to find the correct correspondence. In an example, the process starts from a seed correspondence cₙ={Iₙ^{Q}, Iₙ^{M}}, where Iₙ^{Q} and Iₙ^{M} are two instances from the query scan and the prior map respectively. The process then loops through all candidate correspondences, so another correspondence cm={Iₘ^{Q}, Iₘ^{M}} can be grouped with ex if:

$$‖ {I}_{n}^{Q} - {I}_{m}^{Q} ‖ - ‖ {I}_{n}^{M} - {I}_{m}^{M} ‖ < ϵ \qquad ( 5 )$$

∈ is the parameter that restricts how strictly the grouping algorithm behaves. The accepted consensus group contains a minimum of τ instances. Finally, for the 6 DoF pose estimation, a RANSAC step may be applied on the subset of correspondences to align the query scan with the prior map, with τ and ∈.

Thus, in some examples, matching at least one of the object features to a corresponding feature in an existing map of the environment using the unique descriptor 318 comprises matching one or more object features in the point cloud map to a corresponding feature in the existing map; and identifying a closest match to the corresponding feature from the one or more matched object features using a correspondence grouping method. After identifying several likely matches to each of the object features, the correspondence grouping method is used to eliminate incorrect matches and to check the consistency of correct matches.

From this matching process, pose estimation 320 can be performed to localise the position of the image capture apparatus in the environment; that is, the process 300 comprises localising the position of the imaging apparatus in the environment based on the at least one matched object feature 320. Localising the position of the imaging apparatus may thus comprise identifying the spatial position and directional orientation of the imaging apparatus. An example is shown in FIGS. 4a and 4b

FIG. 4a illustrates a process of matching object features via descriptor and geometric matching. In the matching step 318, first there may be a descriptor matching step 318a to find the closest instance in the prior map. As illustrated, a best match may be identified and other less-well matching options disregarded. Then there may be a geometric matching step 318b to check consistency and find the pose of the image capture device. In this example the known image is illustrated in the map representation on the left and the current captured image is illustrated in the query representation on the right. In both cases a match has been found between the chair and the wall via distance d1, between the chair and the column via distance d2, and between the column and the wall via distance d3.

FIG. 4b shows an example result of matching object features in a captured image to corresponding objects in an existing map resulting the method described above. A ‘live’ lidar scan (top), as the captured point cloud map, has been localized inside the central prior map (bottom) by matching semantically segmented objects shown by lines indicating matches object features in the top scan with objects in the bottom prior scan. The arrow 402 shows the estimated position and directional orientation of the image capture (lidar) apparatus, and the left corner photograph image is the corresponding visual/optical camera view. It can be seen that unique object features including two walls (wall 1, wall 2) a desk, two boards (board 1 and board 2), four sofas (sofa 1, sofa 2, 3, 4), the ceiling, a beam, a column, the floor, and a window are all matched.

### WORKED EXAMPLE

There will now be presented a worked example of the methods discussed above.

### A. Simulated Lidar Data

Training deep learning algorithms can require large amounts of data. To bypass the need to do time-consuming manual labelling, in this worked example, several indoor environments were constructed in the Unreal Engine simulator to take advantage of automatic labelling. As well as being automatic, it eliminates errors in human labelling and can be easily extended to other environments. About 20 unique rooms were created and assembled into six room networks which contained a total of around 1500 objects. The Airsim plugin was used to capture over 90 scans from these spaces. The simulator allowed the lidar settings to be configured, including frequency, range, the field of view, and the number of lidar beams. The simulated lidar configuration used was modelled on the Ouster OS-128 lidar 1, which has around a 50 m range, 90° field of view, and 128 lidar beams. This is a wide field of view and dense lidar. Similarly to the existing indoor point cloud dataset, Stanford 3D Indoor Scene Dataset (S3DIS), 3 object classes were used: ceiling, floor, column, beam, wall, table, chair, bookcase, sofa, window, door, board, and clutter.

### Labeled Data for Instance Segmentation

Each simulated lidar beam that intersects with an object would result in a range measurement and a unique object ID. Using the object ID, a semantic class and an instance number can be assigned. These labels are used in the supervised training of the two networks. Overall, each point has five fields: (X, Y, Z) coordinates, semantic class, and object instance number.

### Triplets for Descriptor Network

To train the descriptor network, object instances were generated as triplets, with anchor, positive and negative instances. First, two scans were generated that are 2 m apart and having a 10° rotation in the simulator. Given that every object in the lidar scan is labelled, the same objects were classified in these two scans as the anchor and positive instance. Another object was then randomly selected as the negative instance. Because the anchor and positive instances have mild viewpoint differences, the objects scanned in the point clouds may have slight changes. These slight appearance changes contribute to algorithm robustness. In total, about 9900 triplet object instances were generated for training, validation, and testing.

### B. Training

Both segmentation and descriptor networks were built with a sparse tensor framework and were trained on a 4 GB mobile GPU, NVIDIA Quadro T2000.

1) Instance Segmentation Network: A pre-existing SoftGroup model (trained on S3DIS) was used as a warm start. The voxel size was set to 2 cm and the minimum number of points in each instance was set to 50. The network was trained for 50 epochs which took about one hour.

2) Instance Descriptor Network: The network was trained from scratch with a triplet loss function (Equation (4) above). Compared to a whole scan (which usually contains over 100,000 points) each triplet instance was only a small fraction of a whole scan; because of this the batch size could be increased to allow parallel input. The descriptor network was trained for 90 epochs, and took around 90 minutes. Both networks were trained with an Adam optimizer with a learning rate of 0.001.

In this section, experiments are described which were conducted on instance segmentation and descriptor networks as discussed above, followed by real world experiments using the examples disclosed herein as a complete localisation system. Tests are presented to show these methods are robust to a changing number of prior map scans which indicates robust performance.

### A. Experimental Setup

A fully labelled simulated dataset to train the instance segmentation and descriptor network was used. The dataset also holds 113 test scans for the instance segmentation network and 2123 test triplet instances for the descriptor network.

For the localisation experiment, an indoor environment dataset was collected using a Ouster lidar OS-128 in small, medium, and large scale buildings. The dataset includes sequences in office rooms, meeting rooms, and social spaces as well as lecture theatres, staircases, and hallways. FIG. 7 shows the prior maps built with a lidar SLAM (simultaneous localisation and mapping) system. The SLAM poses are 0.7m apart so there are 147, 192, and 384 individual scans which form the final map for the illustrated George, Thom, and IEB buildings. As an indication of size, the estimated map floor area for each building is around 500 m², 1100 m², and 2000 m² respectively. However, in these localisation experiments, the prior map is made up of a subset of registered scans that are spaced 2.1 m apart. As the lidar sensor was running at 10 Hz, the localisation system is triggered every ten scans-once per second.

TABLE 1
Numerical summary table showing the performance of methods disclosed herein
compared to two state-of-the-art benchmarks. The prior map is made of N
scans and the query scan is the total number of scans queried.

| | | | | | | | | | | Disclosed | | |
|---|---|---|---|---|---|---|---|---|---|---|---|---|
| | | | | ESM* | | | SegMap* | | | method | | |
| | | Scan | | | | Pre- | | | Pre- | | | Pre- |
| Data | Length | Number | | | Recall | cision | | Recall | cision | | Recall | cision |
| Building | (m) | Map | Query | Detect | % | % | Detect | % | % | Detect | % | % |
| George | 96 | 32 | 106 | 12 | 11 | 75 | 28 | 26 | 81 | 56 | 49 | 93 |
| Thom | 121 | 45 | 137 | 36 | 26 | 92 | 28 | 30 | 93 | 88 | 58 | 91 |
| IEB | 253 | 98 | 211 | 29 | 14 | 93 | 27 | 13 | 56 | 94 | 42 | 95 |

*Note
both methods have been adapted for better performance.

Table 1 presents specific details for each building. For example, the prior map of George Building consists of 32 scans, and the trajectory length is 96 m. In total, 106 scans were queried. A detection is classified as being correct when the estimated pose is within 0.2 m and the orientation is within 10° of the ground truth pose. There is no point cloud alignment step, such as Iterative Closest Point (ICP) refinement, in this example, and the pose estimation is from the instance correspondence matching.

### B. Results

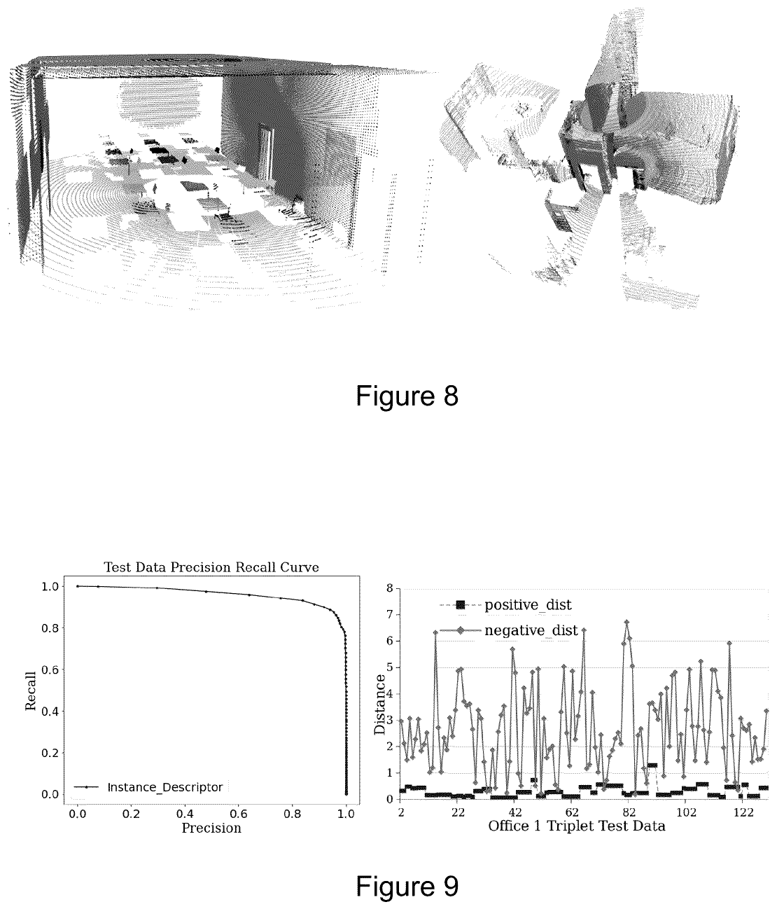

1) Instance Segmentation Results: FIG. 8 shows two illustrations of instance segmentation results. The left side image of a scan is from the simulated dataset. In this classroom environment, each object instance has been assigned a random colour to group that set of points as being representative of the same object. Chairs, tables, and wall surfaces are individually segmented, and each have a different colour (i.e. are grouped together by object instance). The door towards the right of the left-hand image is partially segmented from the wall. In another example result, the right side image of a scan was captured in a hallway in George Building with the Ouster lidar. The hallway connects several rooms with lidar beams scanning into those rooms, which resulted in several partially scanned walls. The ceiling is accurately segmented so all points representing the ceiling are grouped together, but the right-hand wall is mixed with two other different segments. The imperfection in segmentation is expected as the current state-of-the-art instance segmentation method, SoftGroup, achieves an average precision (AP) of around 54.5% on indoor datasets such as the S3DIS dataset. Unlike the S3DIS dataset, there is no visual (e.g. colour) information for lidar points in the simulator synthesized data. In addition, the data obtained in these tests contains a larger variety of spaces and objects than S3DIS, and some objects in the scans are scanned partially. Hence after applying the default SoftGroup on the synthesized data, it reaches 39% average precision across 13 classes.

The proposed improvement of incorporating lidar properties as discussed in relation to FIGS. 1 and 3 improved the AP from 39% to 41%, shown in Table 2. Larger objects such as ceilings, floors, and walls have a higher AP. Objects such as boards, windows, and doors, which are gathered under “other1” and “other2” in Table 2 have much lower AP, less than 20%. One key design consideration for the localisation methods disclosed herein to be able to deal with imperfect segmentation is to use all available instances with descriptors that can tolerate incomplete object point clouds.

TABLE 2
Average precision for each object class. Others1 is
the mean value of table, board, and window, others2
is the mean value of door, bookcase, and clutter.

| Class | AP | Class | AP | Class | AP |
|---|---|---|---|---|---|
| Ceiling | 0.923 | Floor | 0.838 | Wall | 0.565 |
| Column | 0.632 | Beam | 0.367 | Chair | 0.723 |
| Sofa | 0.402 | Others1 | 0.144 | Others2 | 0.163 |

Average AP 41.3

2) Instance Descriptor Results:

In 3D point cloud learning, data representation and augmentation can have a significant impact on achieving on best matching or labelling performance. Experiments were performed with several approaches, and it was found that centring individual instances and applying random rotations during data preparation can optimize learning results. 20% of the points were randomly eliminated in each instance and random noise added to lidar point positions during data preparation to improve descriptor robustness.

FIG. 9 presents descriptor pairwise distances between the anchor, positive and negative instances in a subset of 120 test triplets. On the left of FIG. 9, there is a precision/recall curve for all test data in the descriptor network. On the right of FIG. 9, there is a subset of the test data shown as a dashed line with square points showing the distance between the anchor and the positive instances. The solid line with diamond points shows the distance between the anchor and the negative instances. The square-point lines toward the bottom of the right hand figure correspond to smaller, positive distances (as desired). There is a clear separation between the typical positive and negative distances. The graph in FIG. 9 (left) shows the precision and recall curve for the 2000 test triplets. At a descriptor distance (L2 norm) threshold of 0.56, the model can classify the instances with 91.4% precision and 88.1% recall. Here a smaller distance threshold was purposely chosen to have higher precision as false positives are more detrimental to the localisation system.

The network according to examples disclosed here is fast and efficient. For comparison, a test was performed on the Thom Building dataset. Averaged across all scans, a known ESM descriptor processed 30 segments in a scan in 72 ms, while the descriptor network used as disclosed herein processed 30 instances in 21 ms. In addition, the descriptor network used as disclosed herein can operate on any number of input points, but the known ESM (Efficient Segmentation and Matching) descriptor needs to downsample a segment to 256 points and the known network SegMap uses fixed 3D voxel grid dimension of 32×32×16 which compromises on detail.

3) Localisation Results

Referring to FIG. 4b again, this shows a lidar scan that has been successfully localised within the ground floor of Thom building. Several object instances have been matched including walls, sofas, and flat planes (TV screens). The top section shows the matched instances within the query scan, and the bottom section shows the matched instance within the larger prior map. The estimated pose is indicated with a gold arrow. The methods disclosed herein, and two state-of-the-art known baselines were tested with datasets from George, Thom, and Information Engineering Building (IEB) as shown in Table 1 above.

The methods disclosed herein successfully detected 48 out of 106 scans in the prior map of George building, and all detections were correct according to the ground truth. Hence the recall rate is 45% and the precision is 100%. For Thom building, the recall rate was 56% but the precision was lower at 86%. The lower precision was largely due to the two near identical lecture theatre halls on the two sides of Thom building, shown in FIG. 5. This caused confusion in the localisation system. Over the three sequences, the average recall was around 47%, and the average precision was about 94%. Note that all three datasets are for test, the segmentation and description networks have not seen them as they are trained on simulated lidar scans.

Two known segment-based localisation methods were selected as comparative baselines, as they are most similar to the method disclosed herein. The two known algorithms were modified to the best of our efforts to offer a fair comparison in indoor environments. With ESM, the Euclidean Cluster Extraction (ECE) method was used to segment the lidar scans. As ESM was originally designed for outdoor environments, objects in the scan are expected to be distinctly separated, especially after removing points corresponding to the ground. However, in an indoor environment, the ECE method cannot separate objects efficiently as walls and ceilings often become one segment. To mitigate this, first the curvature was calculated, and high curvature points removed so there are distinct gaps between structured objects. After this, the ECE method can produce more reasonable segments. The second known algorithm tested, SegMap, was first simplified by removing the lidar accumulating through the odometry system, as the lidar scans in our test are from a 128-beam lidar so it is very dense compared to 16 or 32-beam lidar used in the examples according to this disclosure. More importantly, the incremental region growing method was used for segmentation, which computes local normals and curvatures for each point and uses these to extract flat or planar-like surfaces. After these two modifications, the system can operate in real time and have better segmentation performance.

However, even with the adjusting improvements made to the segmentation method in both known systems, there is still a limitation in these descriptor networks. One factor is that they does not use sparse tensor networks unlike the methods disclosed herein, and as a result, only a small and fixed number of points can be used as input. A table presenting comparison results is shown in Table 1. It can be seen that the methods disclosed herein outperforms the known baseline methods by a factor of between two and four times in recall, and also achieves higher precision. In general, these known systems tend to be tuned to prefer higher precision, for accurate and trustworthy localisation.

TABLE 3
Ablation study: varying the number of scans used for the prior map.
The same number of query scans are used as Table 1, R and
P are the recall and precision values respectively.

| Data | Fewer scans | | Default Density | | More Scans | |
|---|---|---|---|---|---|---|
| Building | Map | R/P % | Map | R/P % | Map | R/P % |
| George | 22 | 30/40 | 32 | 45/100 | 48 | 49/84 |
| Thom | 33 | 45/97 | 45 | 56/86 | 60 | 54/86 |
| IEB | 68 | 30/100 | 98 | 41/97 | 125 | 42/93 |

4) Varying the Size of the Prior Map

As a robustness test, experiments were conducted to see how the number of individual scans in a prior map can affect localisation results. Intuitively, as the number of prior map scans is reduced, the localisation detection rate should reduce. Shown in Table 3, the middle column is the baseline which has the same configuration as Table 1, and the columns left and right of it have either an increased or decreased number of prior map scans. With the decreased number of prior map scans, there is a slight reduction in recall values, but no negative effect on precision. This demonstrates the robustness of the disclosed system to changes in the number of prior map scans

### C. CONCLUSIONS

The precision of the instance segmentation disclosed herein can directly impact the performance of the localisation system. Since the descriptor network has already reached high precision and recall values, good instance segmentation is a key way of improving overall localisation recall performance. In our experiments, the instance segmentation network performs well in structured and enclosed spaces such as theatres, classrooms, offices, etc.

In summary, the methods and apparatus disclosed here provide a fast and accurate lidar localisation approach, which is capable of learning to segment and describe different object instances in a scene. It comprises two networks, joined together to recognize and describe individual objects. The disclosed methods can localise between two to four times as many matches as two known state-of-the-art baseline methods while retaining high levels of precision.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features. Many modifications and other examples set out herein will come to mind to a person skilled in the art in light of the teachings presented herein. Therefore, it will be understood that the disclosure herein is not to be limited to the specific examples disclosed herein. Moreover, although the description provided herein provides examples in the context of certain combinations of elements, steps and/or functions may be provided by alternative examples without departing from the scope of the appended claims.

1. A computer-implemented method of localisation of an imaging apparatus in an environment, the method comprising:
receiving a point cloud map indicative of the environment, the point cloud map captured by the imaging apparatus located at a position within the environment;
segmenting the point cloud map into a plurality of object segments each comprising an object feature;
assigning a unique descriptor to each of the object features;
matching at least one of the object features to a corresponding feature in an existing map of the environment using the unique descriptor; and
localising the position of the imaging apparatus in the environment based on the at least one matched object feature.

2. The method of claim 1, comprising matching a plurality of the object features to respective corresponding features in the existing map of the environment using the unique descriptors of the plurality of the object features; and
localising the position of the imaging apparatus in the environment based on the plurality of matched object features.

3. The method of claim 2, wherein each object feature belongs to an object category indicating the type of object, and at least two of the plurality of the object features belong to different object categories.

4. The method of claim 1, wherein the point cloud map represents an image of the environment captured by the imaging apparatus in a single position and a single orientation within the environment.

5. The method of claim 1, wherein segmenting the point cloud map comprises representing the point cloud map using sparse tensors.

6. The method of claim 1, wherein segmenting the point cloud map comprises, for each point in the point cloud map:
predicting a semantic label indicating an object class of the object feature comprising the point; and
predicting an instance label indicating a unique instance of the object feature comprising the point.

7. The method of claim 1, wherein segmenting the point cloud map comprises grouping a plurality of points in the point cloud map, the plurality of points associated with an object feature.

8. The method of claim 7, wherein the point cloud map is obtained using depth imaging, and grouping the plurality of points is performed using an adaptive radius threshold proportionate to a vertical distance between two depth imaging beams used to capture the point cloud map.

9. The method of claim 1, wherein segmenting the point cloud map is performed using a neural network.

10. The method of claim 1, wherein assigning the unique descriptor comprises:
for each of the object features, each of the object features comprising a plurality of points of the point cloud map;
using a network comprising a series of convolutional layers to generate a plurality of point descriptors each corresponding to a particular point in the plurality of points of the object feature; and
pooling the plurality of point descriptors to generate the unique descriptor of the object feature.

11. The method of claim 1, wherein assigning the unique descriptor is performed using a neural network.

12. The method of claim 1, wherein matching at least one of the object features to a corresponding feature in an existing map of the environment using the unique descriptor comprises:
matching one or more object features in the point cloud map to a corresponding feature in the existing map; and
identifying a closest match to the corresponding feature from the one or more matched object features using a correspondence grouping method.

13. The method of claim 1, wherein the plurality of object segments comprises a first object feature in a first object segment and a second object feature in a second object segment, and wherein the first object feature comprises a different number of points of the point cloud map than the second object feature.

14. The method of claim 1, wherein the environment is an indoor environment.

15. The method of claim 1, wherein the imaging apparatus is a lidar and the point cloud map captured by the imaging apparatus is a lidar map.

16. The method of claim 1, wherein localising the position of the imaging apparatus comprises identifying the spatial position and directional orientation of the imaging apparatus.

17. An apparatus configured to localise an imaging apparatus in an environment, the apparatus comprising:
an input module configured to receive a point cloud map indicative of an environment, the point cloud map captured by the imaging apparatus located at a position within the environment;
a segmentation module configured to segment the point cloud map into a plurality of object segments each comprising an object feature;
a descriptor module configured to assign a unique descriptor to each of the object features in the point cloud map;
a matching module configured to match at least one of the object features to a corresponding feature in an existing map of the environment using the unique descriptor; and
a localisation module configured to localise the position of the imaging apparatus in the environment based on the at least one matched object feature.

18. The apparatus of claim 17, wherein one or more of:
the segmentation module comprises a neural network configured to segment the point cloud map into the plurality of object segments; or
the descriptor module comprises a neural network configured to assign the unique descriptor to each of the object features.

19. The apparatus of claim 17, wherein:
the apparatus comprises the imaging apparatus located with the apparatus;
the imaging apparatus is configured to capture the point cloud map and provide the point cloud map to the input module; and
the localisation module is configured to localise the position of the apparatus.

20. A machine-readable medium having program code stored thereon which, when executed by a computer, causes the computer to perform the method of claim 1.
